(19) United States
(12) Patent Application Publication
(10) Pub. No.: US 2026/0357885 A1
(43) Pub. Date: Nov. 12, 2026

(54) MULTIFUNCTIONAL HOUSING AND ELECTRIC FINAL DRIVE TRAIN

(71) Applicant: Schaeffler Technologies AG & Co. KG, Herzogenaurach (DE)

(72) Inventors: Lars SCHUMANN, Bühl (DE); Torsten PIEPER, Weingarten (DE)

(73) Assignee: Schaeffler Technologies AG & Co. KG, Herzogenaurach (DE)

(21) Appl. No.: 19/491,560

(22) PCT Filed: Jun. 14, 2024
(86) PCT No.: PCT/DE2024/100523

§ 371 Date: Dec. 9, 2025

(30) Foreign Application Priority Data
Jun. 15, 2023 (DE) 10 2023 115 577.6

(51) Int. Cl. F16H 57/04; F16H 57/02; F16H 57/021

(52) U.S. Cl. CPC F16H 57/0424; F16H 57/021; F16H 57/0404; F16H 57/0417; F16H 57/0435; F16H 2057/02026; F16H 2057/02052

(57) ABSTRACT

A multifunctional housing for accommodating components of an electric final drive train for a motor vehicle. In order to simplify provision of different fluids in the electric final drive train for the motor vehicle, the multifunctional housing has a central housing body into which fluid ducts for different fluids are integrated.

### CROSS-REFERENCE TO RELATED APPLICATIONS

This application is the U.S. National Phase of PCT Appin. No. PCT/DE2024/100523, filed Jun. 14, 2024, which claims the benefit of German Patent Appln. No. 102023115577.6, filed Jun. 15, 2023, the entire disclosures of which are incorporated by reference herein.

### TECHNICAL FIELD

The disclosure relates to a multifunctional housing for receiving components of an electric axle drive train for a motor vehicle. The disclosure further relates to an electric axle drive train for a motor vehicle having such a multifunctional housing.

### BACKGROUND

A detailed description of an electric drive can be found in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor that is arranged to be concentric and coaxial with a bevel gear differential, wherein a shiftable 2-speed planetary gear set is arranged in the power train between the electric motor and the bevel gear differential and is also positioned to be coaxial with the electric motor or the bevel gear differential or spur gear differential. The drive unit is very compact and allows for a good compromise between gradability, acceleration and energy consumption due to the shiftable 2-speed planetary gear set. Such drive units are also referred to as e-axles or electrically operable axle drive trains. The German published patent application DE 10 2018 124 220 A1 discloses an electric pump actuator, in particular for the actuation of a clutch, in particular in the drive train of a motor vehicle, comprising a pump and an electric motor, wherein the pump and the electric motor are provided in a single-piece housing which has a closable mounting opening at least one end face. The German published patent application DE 10 2021 129 917 A1 discloses an exhaust manifold for an engine, comprising: a plurality of exhaust manifold tubes coupling a plurality of cylinder exhaust outlet ports to an exhaust outlet port, wherein the plurality of exhaust manifold tubes form at least a first exhaust passage and a second exhaust passage at the exhaust outlet port; an upper cooling jacket positioned vertically above the first exhaust passage; a lower cooling jacket positioned vertically below the central cooling jacket positioned vertically below the first exhaust passage and vertically above the second exhaust passage.

### SUMMARY

The object of the disclosure is to simplify the provision of different fluids in an electric axle drive train for a motor vehicle.

The object is achieved in a multifunctional housing for receiving components of an electric axle drive train for a motor vehicle, in that the multifunctional housing comprises a central housing body into which fluid channels for different fluids are integrated. The electric axle drive train comprises at least one traction machine, power electronics and a transmission. The central housing body with the fluid channels considerably simplifies the implementation of different fluid circuits for supplying the components of the electric axle drive train with different fluids. Bores and labyrinths to provide the fluid circuits are preferably designed as cast geometries. Depending on the required accuracy, for example in the region of valve seats, mechanical finishing, in particular by way of machining, may be necessary. According to a further aspect, filters required in the fluid circuits are integrated into the fluid channels. The filters are advantageously arranged in the fluid channels in such a way that they can be easily replaced after the disassembly of peripheral components. With the disclosed multifunctional housing, an electric axle drive train can be realized which, in addition to the traction machine, the transmission and the power electronics, also comprises cooling and air conditioning components. The different fluids comprise at least one cooling and/or lubricating medium and another medium that is compressible, at least in certain states.

A preferred exemplary embodiment of the multifunctional housing is characterized in that the central housing body comprises bearing mounts for at least two transmission shafts. The central housing body is preferably used to provide a transmission housing body. This transmission housing body has a transmission side with which the central housing body can be attached to a transmission housing with a transmission. In addition, the central housing body advantageously has a traction machine side facing away from the transmission side, on which the traction machine is attached to the central housing body. The bearing mounts for the at least two transmission shafts are advantageously supplied with a suitable cooling and/or lubricating medium via the fluid channels.

A further preferred exemplary embodiment of the multifunctional housing is characterized in that the central housing body comprises fluid channels for a cooling and/or lubricating medium. The cooling and/or lubricating medium is, for example, an oil that is suitable for both lubricating and cooling, in particular of transmission components such as bearing components. However, the fluid can also be water, which is mainly used for cooling. The cooling and/or lubricating medium is preferably an incompressible medium.

A further preferred exemplary embodiment of the multifunctional housing is characterized in that the central housing body comprises fluid channels for a refrigerant. The refrigerant is preferably a medium that is compressible, i.e., in particular gaseous, at least in certain states. The fluid channels for the refrigerant are preferably used to provide a refrigerant circuit, for example for an air conditioning system, in the central housing body.

A further preferred exemplary embodiment of the multifunctional housing is characterized in that the central housing body has an attachment interface for an accumulator and/or a filter device. The accumulator is preferably assigned to the refrigerant circuit of the air conditioning system. The attachment interface for the accumulator is preferably provided on the traction machine side of the central housing body. This simplifies connecting the accumulator. The attachment interface for the optional filter device is preferably a recess provided for this purpose, for example, in a fluid channel or at the end of a fluid channel. The filter device is preferably a filter integrated into the line. For this purpose, a seat for this line-integrated filter is advantageously provided in a line to be equipped with the filter.

A further preferred exemplary embodiment of the multifunctional housing is characterized in that the central housing body has attachment surfaces for at least two valve plates which, in combination with the fluid channels in the central housing body, provide fluidically separated fluid circuits for different fluids. One of the valve plates, in combination with corresponding fluid channels in the central housing body, preferably serves to provide a lubrication and/or cooling circuit in the multifunctional housing. The other valve plate, in combination with corresponding fluid channels in the central housing body, preferably serves to provide a refrigerant circuit in the multifunctional housing. The valve plates are secured to the central housing body in a manner that is at least fluid pressure-tight, preferably with the interposition of suitable sealing devices. Various joining techniques, such as screwing, gluing, welding or soldering, can be used to secure the valve plates. The fluid channels preferably extend in a main direction, which is referred to as the longitudinal direction, for example. Transverse bores used to provide functional circuits are preferably designed to be short. All bore openings are preferably part of the respective fluid circuit. The fluid circuit is closed or covered by the aforementioned sealing devices or valve plates. This has the advantage that separate closure elements and correspondingly precise connection geometries can be dispensed with.

A further preferred exemplary embodiment of the multifunctional housing is characterized in that the valve plates have attachment surfaces for a lead frame. Owing to the lead frame, connections to the multifunctional housing can advantageously be made in just a single assembly step. The connections advantageously comprise the majority of the required electric and/or fluidic connections. The connections comprise supply interfaces, sensor interfaces and line interfaces. All connections are advantageously designed as plug-in connections. The plug-in connections are particularly advantageously aligned in one direction. This means that all required electric contacts and all required fluid connections can be made with and/or on the disclosed lead frame in a single assembly step.

A further preferred exemplary embodiment of the multifunctional housing is characterized in that the valve plates and the central housing body have attachment interfaces for valve devices. The valve devices comprise different components. The components are, for example, so-called cartridge valves, retaining magnets or other valves or valve elements, in particular check valves. In addition, the valve plates and the central housing body advantageously comprise connection interfaces or attachment interfaces for pumps or compressors. The valve devices are preferably integrated into the valve plates. However, it is also possible to connect individual valve devices to the central housing body via a separate interface.

A further preferred exemplary embodiment of the multifunctional housing is characterized in that the valve plates and the central housing body have connection interfaces for fluid lines. These connection interfaces are preferably standardized. In addition, the connection interfaces on the valve plates and the central housing body are advantageously arranged and aligned such that a connection is particularly advantageously made possible in just a single assembly step.

The object specified above is also achieved by an electric axle drive train for a motor vehicle having a multifunctional housing as described above. The electric axle drive train preferably comprises at least one electric traction machine, which can be connected or is connected to at least one wheel of the motor vehicle via a transmission in a driving manner. The transmission and the electric traction machine are integrated into a fluid system, at least for cooling and/or lubrication, which is implemented with the aid of the multifunctional housing as described above. In addition to the electric traction machine, the transmission and the power electronics, the disclosed electric axle drive train also advantageously comprises cooling and air conditioning components with fluid circuits that are integrated into the multifunctional housing.

The disclosure may also relate to at least one separately tradable individual part for a previously described multifunctional housing.

### BRIEF DESCRIPTION OF THE DRAWINGS

Further advantages, features and details of the disclosure are ap-parent from the following description, in which various exemplary embodiments are described in detail with reference to the drawing. In the drawing:

FIG. 1 shows a perspective view of a central housing body of a multifunctional housing, with a view of a traction machine side;

FIG. 2 shows the central housing body from FIG. 1 with a view of one transmission side;

FIG. 3 shows the same view as in FIG. 1, wherein two valve plates and a lead frame are attached to the central housing body;

FIG. 4 shows the same view as in FIG. 2, wherein the two valve plates and the lead frame are also attached to the central housing body here;

FIG. 5 shows an enlarged section of FIG. 3 without the lead frame;

FIG. 6 shows a sectional view of one of the valve plates in FIG. 4; and

FIG. 7 shows an enlarged top view of an attachment surface for one of the valve plates on the central housing body.

### DETAILED DESCRIPTION

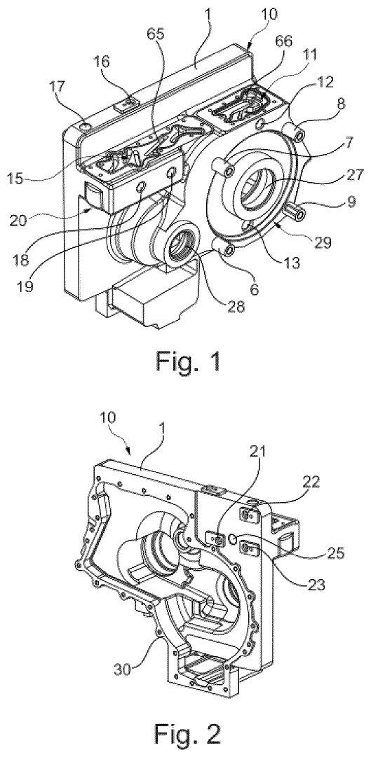

FIGS. 1 to 6 show a multifunctional housing 10 having a central housing body 1 in various perspectives and views. The multifunctional housing 10 is used for receiving components of an electric axle drive train 40.

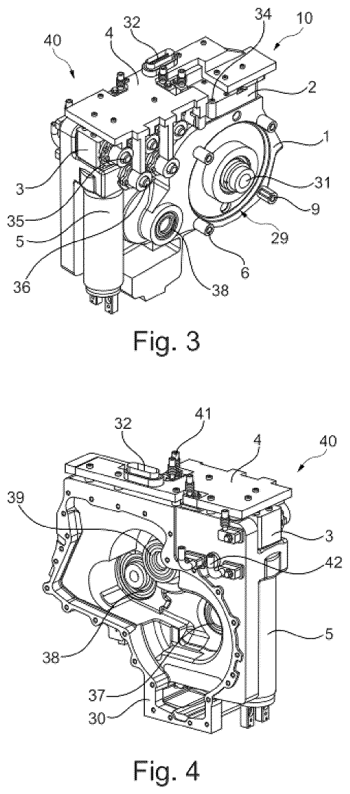

The multifunctional housing 10 with the central housing body 1 comprises a traction machine side 29 facing a traction machine, which can be seen in FIGS. 1 and 3, and a transmission side 30 facing a transmission, which can be seen in FIGS. 2 and 4.

The multifunctional housing 10 is designed in multiple parts and, in addition to the central housing body 1, comprises two valve plates 2, 3, a lead frame 4 and an accumulator 5. Together with the central housing body 1 and the lead frame 4, the valve plate 2 serves to provide a labyrinth-like fluid circuit for a hydraulic medium, which is also referred to as oil for short. The corresponding fluid circuit is therefore also referred to as an oil circuit.

Together with the central housing body 1 and the lead frame 4, the valve plate 3 serves to provide a fluid circuit for a refrigerant that is independent of the oil circuit. This fluid circuit is therefore also referred to as a refrigerant circuit. The oil circuit is fluidically separated from the refrigerant circuit in the central housing body 1.

As can be seen in FIG. 1 among other things, the central housing body 1 has an attachment interface 20 for the accumulator 5 on its traction machine side 29, which in turn is shown in FIG. 3. In addition, the central housing body 1 has four attachment elements 6, 7, 8, 9 for the traction machine arranged on a pitch circle on its traction machine side 29. The attachment elements 6 to 9 are used in particular to center the traction machine in the installed state and to support it when transmitting torque.

The central housing body 1 has an attachment surface 11 at the top for the valve plate 2. The attachment surface 11 for the valve plate 2 comprises a labyrinth of fluid channels 66 which, together with corresponding fluid channels in the central housing body 1, serve to provide the oil circuit.

The oil circuit comprises line connections 12 and 13 on the traction machine side 29 of the central housing body 1. The line connection 12 is a cooling oil return, for example. The line connection 13 is a cooling oil inlet, for example. The cooling oil is provided by a suitable pump, for example. The cooling oil is then supplied to a heat exchanger, for example, via the line connection 12.

In addition, the central housing body 1 has an attachment surface 15 for the valve plate 3. The attachment surface 15 comprises a labyrinth of fluid channels 65 which, together with corresponding fluid channels in the central housing body 1, serve to provide the refrigerant circuit.

In FIG. 1, the central housing body 1 has a line connection 16 at the top. In addition, the refrigerant circuit has connection interfaces 21, 22 and 23 on the transmission side 30, as can be seen in FIG. 2. A sensor connection 25 is also provided between the connection interfaces 21 and 23 on the transmission side 30 of the central housing body 1.

In addition, the central housing body 1 is equipped with valve seats 17, 18, 19 of valve devices for the refrigerant circuit. Two transmission interfaces 27, 28 are used in the central housing body 1 for the passage of transmission shafts, of which one transmission shaft 31 is shown in FIG. 3. The transmission shaft 31 is preferably a transmission input shaft. The transmission input shaft is used to provide a drive connection with a rotor of the traction machine.

The lead frame 4 comprises a central connection 32. The valve plates 2 and 3 are secured to the central housing body 1 by means of screw connections 34. Sealing devices are provided for sealing between the valve plates 2, 3 and the central housing body 1, of which one sealing device 60 is shown in section in FIG. 6. The sealing device 60 preferably comprises a sealing plate combined with a suitable seal.

The refrigerant circuit comprises valve devices 35 with retaining magnets 36, which are attached to the valve plate 3 and, in the region of the valve seats 18, 19, to the central housing body 1, as can be seen in FIG. 3. FIGS. 3 and 4 show that bearings 37, 38, 39 are installed in the central housing body 1. The bearings 37 and 38 are used to support two transmission shafts. The bearing 39 is used to support an intermediate shaft.

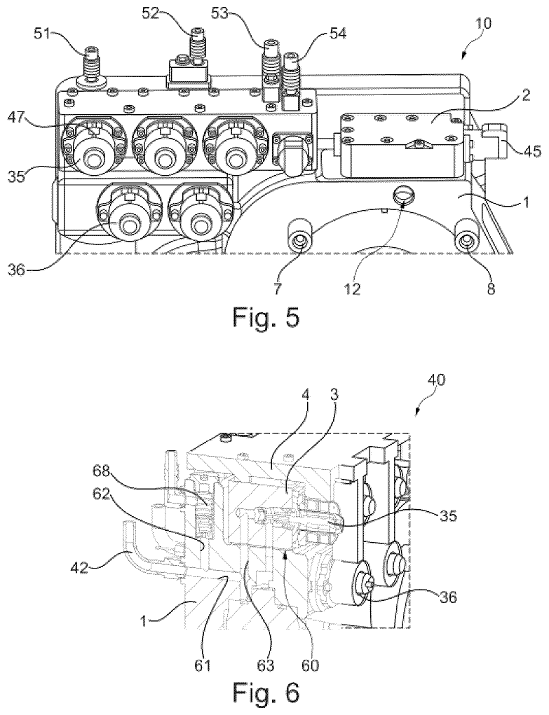

FIG. 5 shows that the valve devices 35 and the retaining magnets 36 are all contacted in one mounting direction, in FIG. 5 from above. As can be seen in FIG. 5, connection elements 51 to 54 are mounted in the same mounting direction, i.e., from above in FIG. 5. A switch magnet 45 with a contact 47 is contacted in the same mounting direction, in FIG. 5 from above. This alignment considerably simplifies assembly, in particular making connections.

FIG. 6 shows that fluid channels in the valve plate 3 and in the central housing body 1 are provided by means of the bores 61 to 63. The bores 62 and 63 are also referred to as longitudinal bores. Analogously, the bore 61 is referred to as a transverse bore. In general, transverse bores in the multifunctional housing 10 are designed to be significantly shorter than longitudinal bores.

FIG. 6 shows how the valve device 35, designed as a switching valve, is combined with a check valve 68 in the multifunctional housing 10. The valve device 35 is arranged in the valve plate 3. The check valve 68 is arranged in the central housing body 1.

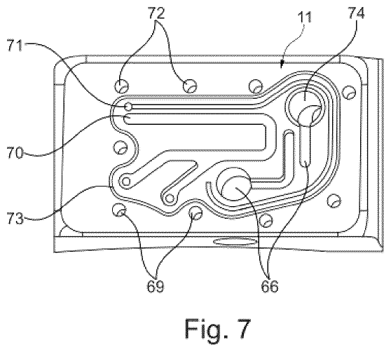

FIG. 7 shows the attachment surface 11 for the valve plate 2 on the central housing body 1 in a top view by itself. The enlarged view shows that the attachment surface 11 has a total of nine holes 72 on the outside for screw connections. The holes 72 for screw connections are arranged outside of a sealing groove 73. Multiple bores 69, an optional dummy line 70, and a leakage return 71 in a transmission chamber are provided within the sealing groove 73. In addition, an optional seat 74 for a filter device is provided within the sealing groove 73. The filter device is a filter integrated into the line.

### LIST OF REFERENCE SYMBOLS

1 Central housing body
2 Valve plate
3 Valve plate
4 Lead frame
5 Accumulator
6 Attachment element
7 Attachment element
8 Attachment element
9 Attachment element
10 Multifunctional housing
11 Attachment surface
12 Line connection
13 Line connection
15 Attachment surface
16 Line connection
17 Valve seat
18 Valve seat
19 Valve seat
20 Attachment interface
21 Connection interface
22 Connection interface
23 Connection interface
25 Sensor connection
27 Transmission interface
28 Transmission interface
29 Traction machine side
30 Transmission side
31 Transmission shaft
32 Central connection
34 Screw connection
35 Valve device
36 Retaining magnet
37 Bearing
38 Bearing
39 Bearing
40 Electric axle drive train
41 Line connection
42 Line connection
45 Switch magnet
47 Contact
51 Connection element
52 Connection element
53 Connection element
54 Connection element
60 Sealing device
61 Bore
62 Bore
63 Bore
65 Fluid channels
66 Fluid channels
68 Check valve
69 Bores
70 Optional dummy line
71 Leakage recirculation
72 Holes for a screw connection
73 Sealing groove
74 Optional seat of a filter device

1. A multifunctional housing for receiving components of an electric axle drive train for a motor vehicle, the multifunctional housing comprising:
a central housing body into which fluid channels for different fluids are integrated.

2. The multifunctional housing according to claim 1, wherein the central housing body includes bearing mounts for at least two transmission shafts

3. The multifunctional housing according claim 1, wherein the central housing body includes fluid channels for at least one of a cooling or lubricating medium.

4. The multifunctional housing according to claim 3, wherein the central housing body includes fluid channels for a refrigerant.

5. The multifunctional housing according to claim 1, wherein the central housing body has an attachment interface for at least one of an accumulator or a filter device.

6. The multifunctional housing according to claim 4, wherein the central housing body has attachment surfaces for at least two valve plates which, in combination with the fluid channels in the central housing body for at least one of a cooling or lubricating medium and for a refrigerant, provide fluidically separated fluid circuits for different fluids.

7. The multifunctional housing according to claim 6, wherein the valve plates have attachment surfaces for a lead frame.

8. The multifunctional housing according to claim 6, wherein the valve plates and the central housing body have attachment interfaces for valve devices.

9. The multifunctional housing according to any one of claim 6, wherein the valve plates and the central housing body have connection interfaces for fluid lines.

10. An electric axle drive train for a motor vehicle comprising:
a multifunctional housing, the multifunctional housing including:
a central housing body into which fluid channels for different fluids are integrated.

11. The electric axle drive train according to claim 10, wherein the central housing body includes bearing mounts for at least two transmission shafts.

12. The electric axle drive train according claim 10, wherein the central housing body includes fluid channels for at least one of a cooling or lubricating medium.

13. The electric axle drive train according to claim 12, wherein the central housing body includes fluid channels for a refrigerant.

14. The electric axle drive train according to claim 10, wherein the central housing body has an attachment interface for at least one of an accumulator or a filter device.

15. The electric axle drive train according to claim 14, wherein the central housing body has attachment surfaces for at least two valve plates which, in combination with the fluid channels in the central housing body for at least one of a cooling or lubricating medium and for a refrigerant, provide fluidically separated fluid circuits for different fluids.

16. The electric axle drive train according to claim 15, wherein the valve plates have attachment surfaces for a lead frame.

17. The electric axle drive train according to claim 15, wherein the valve plates and the central housing body have attachment interfaces for valve devices.

18. The electric axle drive train according to claim 15, wherein the valve plates and the central housing body have connection interfaces for fluid lines.
